(19) United States
(12) Patent Application Publication
(10) Pub. No.: US 2013/0018625 A1
(43) Pub. Date: Jan. 17, 2013

(54) APPLIANCE MONITORING SYSTEM

(71) Applicant: Thomas Lehman, Lees Summit, MO (US)

(72) Inventor: Thomas Lehman, Lees Summit, MO (US)

(21) Appl. No.: 13/530,233

(22) Filed: Jun. 22, 2012

Related U.S. Application Data
(60) Provisional application No. 61/507,497, filed on Jul. 13, 2011.

(51) Int. Cl. G06F 15/00; G06F 19/00

(52) U.S. Cl. 702/130; 702/188; 702/150; 702/41

(57) ABSTRACT

An apparatus and associated method are generally directed to a system of monitoring an appliance. Various embodiments can have a number of appliance subsystems with real and imaginary current associated therewith. The operating characteristics of each appliance subsystem may be learned by monitoring the real and imaginary current associated with each appliance subsystem over time, and operating profiles can be derived therefrom.

### RELATED APPLICATIONS

The present application makes a claim of domestic priority to U.S. Provisional Patent Application No. 61/507,497 tiled Jul. 13, 2011.

### SUMMARY

A number of appliance subsystems can be operated with real and imaginary current. The operating characteristics of each appliance subsystem may be learned by monitoring the real and imaginary current consumption for each appliance subsystem over time.

### BRIEF DESCRIPTION OF THE DRAWINGS

FIG. 1 is a block representation of an example appliance constructed and operated in accordance with various embodiments of the present invention.

FIG. 2 shows a block representation of an example controller circuit capable of being used in the appliance of FIG. 1.

FIG. 3 displays a block representation of example appliance operation in accordance with various embodiments of the present invention.

FIG. 4 plots exemplary operation of an appliance in accordance with various embodiments.

FIG. 5 is a block representation of an example control circuitry capable of being used in the appliance of FIG. 1.

FIG. 6 graphs exemplary operational characteristics of an appliance.

FIG. 7 provides a flowchart of an appliance monitoring routine carried out in accordance with various embodiments of the present invention.

### DETAILED DESCRIPTION

The present disclosure generally relates to monitoring operation of an appliance, particularly appliances with a number of cyclic appliance subsystems. With the emergence of sophisticated appliances with a plurality of subsystems, management of the various subsystems has become increasingly complex. Such complexity is compounded with increasingly sensitive mechanical components that may provide little outward indication of improper operation. As such, monitoring an appliance to determine when and how each subsystem is operating can provide real-time indication of subsystem errors.

By learning each appliance subsystems through monitored appliance operation, ranges of proper operation can be generated to quickly identify improper appliance subsystem operation that can subsequently be alerted to a user. Monitoring appliance subsystem operation can further allow for influx of various sensed measurements, such as internal and external temperature, that can trigger relearning of the appliance subsystems an allow for intelligent future operation of the appliance based on predetermined parameters, like reduced energy consumption and faster initialization.

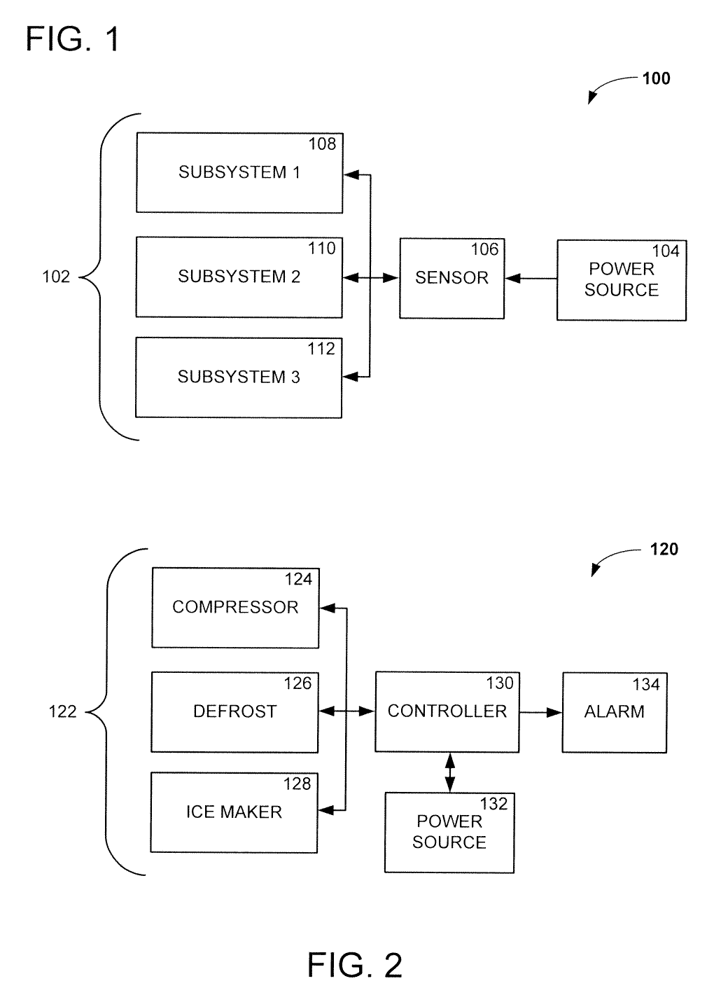

Turning to the drawings, FIG. 1 provides an example appliance system 100 capable of being used in accordance with various embodiments of the present invention. The system 100 has at least one appliance 102 that operates with power from a power source 104. Any number of sensors 106 can be placed throughout the system to monitor a variety of different parameters, such as current flowing from the power source 104 to the appliance 102, time, temperature of the appliance 102, and temperature of the environment external to the appliance 102.

Supplied power can be used to run one or more appliance subsystems 108-112 that may operate individually or in conjunction to provide predetermined appliance function. With an increasing number of appliance subsystems 108-112, automatically determining if and which subsystem 108-112 is operating becomes increasingly difficult. While probes and sensors may be placed with each subsystem 108-112 to collect data to determine which subsystem 108-112 is operating, placement, configuration, and maintenance of such probes and sensors can lead to inaccurate readings and inefficient appliance 102 operation.

Accordingly, some embodiments of the present invention learns the appliance subsystems 108-112 with novel hardware and software that monitors real and imaginary current travelling from the power source 104 to each appliance subsystem 108-112. Monitoring currents can be done quickly and reliably with current detectors that lack high maintenance requirements and allow for accurate and automatic determinations of when and how appliance subsystems 108-112 are operating. As used herein the term imaginary current shall be construed to mean current that is ninety degrees)(90° out of phase with its corresponding voltage.

Moreover, the ability for the novel hardware and software to learn the number and operating behavior of each appliance subsystem 108-112 allows for implementation in virtually any electronic appliance. Such broad applicability is further enhanced by the ability to generate normal operating ranges and error points that identify improper subsystem operation for the particular appliance. The optimization of error points and operating ranges for the particular appliance and appliance subsystem 108-112 may provide timely notification of operating errors that can lead to reduced appliance 102 downtime and enhanced appliance 102 efficiency.

FIG. 2 generally illustrates a block diagram of an example controller circuit 120 capable of being used in the appliance system 100 of FIG. 1. The controller circuit 120 has an appliance 122 with several appliance subsystems 124-128 which each operate individually to provide various functions to the appliance 122. A controller 130 may be oriented to detect and direct real and imaginary current from a power source 132 to the appliance 122. The controller 130 may have one or more sensors, such as sensor 106, placed throughout the circuit 120 to accurately detect power consumption of the appliance subsystems 124-128 as well as other operating characteristics like temperature, pressure, and operating time.

While the various subsystems 124-128 of appliance 122 are specifically named in FIG. 2, such subsystems are not required or limited as any type, number, and function can be utilized either in isolation or in combination to provide appliance 122 operations. The various functions and operations of the appliance 122 can be collected and computed by the controller 130 to generate alarm trip points that correspond to predetermined operating characteristics, such as elevated temperature and power consumption.

The controller 130 can further log the real and imaginary power use profiles of the appliance 122 over time to learn the number and operating behaviors of each subsystem 123-128, which allows for accurate and optimized alarm trip points to be generated for each subsystem 124-128. For example, the controller 130 can learn to identify when the compressor 124, defrost 126, and ice maker 128 are operating individually or in combination and when each subsystem 124-128 stops operating, based on the learned real and imaginary current use profile over time. The cyclic operating nature of many appliance subsystems 124-128 allow the controller 130 the ability to tune the alarm trip points particularly to each subsystem 124-128 to provide enhanced performance.

The precisely generated alarm trip points can be continually monitored and regenerated based upon various parameters to provide adaptive operating behaviors and more accurate alarm notification through, for example but not limited to, the sounding of an alarm 134. It should be noted that no particular type or number of alarms 134 are required or limited as various audible. visual, and tactile notification systems can be used alone or in combination to alert a user that one or more appliance subsystems 124-128 are not operating within designated parameters. The monitoring solely of real and imaginary currents in an appliance system, coupled with environmental measurements, aids in the ability to learn the appliance subsystems 124-128 and generate accurate alarm trip points due to the accurate indication of when a subsystem is and is not operating, relative to its environment.

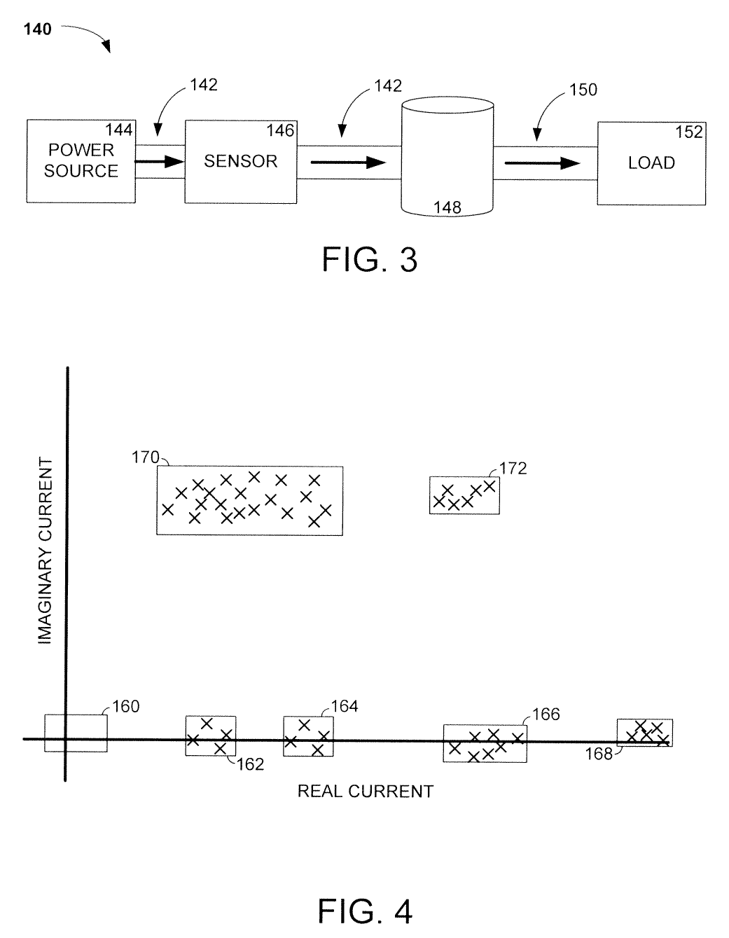

FIG. 3 displays a block diagram of an example power system 140 that generally illustrates exemplary operation of an appliance that includes real and imaginary current. One or more loads 142, such as loads 124, 126, and 128 of FIG. 2. are connected to a power source 144 via a sensor 146. Both real and imaginary types of current may be sensed by the through sensor 146 as current is drawn from the power source 144 by the load 142. The construction of the load 142 determines the types of current consumed by the load 142.

The voltage across the system 140 times the current flowing into the device gives the instantaneous power consumed by the system 140. In a non-limiting example, when an incandescent light bulb is connected to a positive DC voltage source, the current to the light bulb times the voltage across the light gives a positive power consumption number. if the voltage applied to the bulb is reversed then the current will reverse (become negative) and the product will still be positive. When a light bulb is connected to an AC source. half the time the voltage is positive and the other half of the time the voltage is negative. Since the exact same thing can be said for the current, the calculated power consumed by an incandescent light bulb is always positive.

However, if the voltage is a sine wave, the current will be a sine wave and the two waves will be in phase, which corresponds to the phase angle between the voltage and current being 0 and the current being characterized as real since all of it is used to light the bulb. The replacement of the light bulb with a perfect inductor adds the ability to store energy in various components, such as coil windings. Thus, for AC electricity, ¼ of the cycle energy flows from the power source to the inductor and is stored in the inductors magnetic field. During the next ¼ cycle, the energy reverses direction and flows from the inductor to the power source. Accordingly, the average power consumption by the inductor is zero.

In other words, the current sine wave will be 90 degrees out of phase with the voltage sine wave. Even though there is a large current the net power consumption is zero. Hence, currents that are 90 degrees out of phase with the supplied voltage can be characterized as imaginary since no net power is transferred.

Applying the non-limiting example to FIG. 3, if load 142 was a light bulb, the measured current from the sensor 146 would be real. In contrast, if load 152 was a perfect inductor or perfect capacitor, it would consume only imaginary current. If 142 was an induction motor the real part of the current would change with the mechanical load on the motor. whereas the imaginary current would remain relatively constant.

FIG. 4 plots an example appliance operation over time that includes measurement of both real and imaginary currents in accordance with various embodiments of the present invention. During operation of an appliance, a controller can identify when, how much, and what type of current is being consumed. After a predetermined duration of operation, such as one second or one minute, the controller can log the operation as a function of real and imaginary current, as shown in FIG. 4.

Over time with a number of different subsystem operations logged, the data may be analyzed by the controller to identify the number and type of subsystems, which allows for future identification of particular subsystem operation in response to the measured real and imaginary current.

Turning to FIG. 4 as a non-limiting example is a graphical representation of plurality of data log memory spaces in a memory of the controller 130. an all off box 160 can be drawn about the origin of the graph to indicate negligible sensed current and no subsystem operating. With a conglomeration of logged data points surrounding a particular current reading, novel software stored in the memory and used by the controller can draw other boxes to indicate a particular subsystem as a function of real and imaginary current. As shown, minimal imaginary current corresponds with first 162 second 164, and third 166 subsystems that are each separated by enough current range to accurately identify each subsystem individually. In addition a measured level of imaginary current combined with measured real current clearly identities the fourth 168 and fifth 170 subsystems.

With the various data points logged and subsystems learned, the controller can discontinue data logging or continue logging to further refine the extent of each box and the accuracy of the learned environment. For example, newly logged data points would be checked by the controller for consistency with existing subsystem boxes 162-172 and the boxes would be modified. as needed, to accommodate the newly checked data point. In the event that two or more boxes touch, the controller can collect new data to distinguish the subsystems or merge the boxes into a single subsystem.

Such learning of environment just by monitoring the current consumption of an appliance provides seamless operation and continually more accurate identification of the type and number of appliance subsystems. The continued logging of data points further provides the ability to adapt to changing environments where subsystems are added or subtracted from the appliance without recalibration of sensors or the controller, thus reducing appliance downtime and enhancing appliance efficiency.

In various non-limiting embodiments, a refrigerator is the appliance which learns, over time, that box 170 of FIG. 4 is the compressor by itself, box 164 is the ice maker by itself, and box 166 is the defrost by itself. Since the compressor and the defroster normally do not run at the same time, it is uncommon to experience all three devices on at the same time. However, if two devices are on at the same time, then the currents add, which corresponds to box 172 which is learned as the compressor and ice maker being simultaneously operational and box 168 is the defrost and ice maker box being simultaneously operational.

The plotting of real and imaginary current consumption over a variety of operational conditions, such as time. internal temperature. and external temperature, allows for reliable identification of various appliance devices by monitoring for changes in learned operational behavior. Thus, a change in current from box 172 to box 170 can be learned to correspond to the ice maker turning off. The same is true for boxes 168 to 166 or box 164 to 160. In all these cases, the particular appliance subsystem, i.e. ice maker, turned off, but such learning can occur in the reverse as increase current transitions are determined to mean that appliance subsystems just turned on.

Further in the exemplary embodiment, transition from box 160 to box 170 and a transition from box 164 to 172 can relate to an appliance compressor turning on. Of course, a reverse transition can correspond to the compressor turning off. With a transition from box 160 to 166 and from box 164 to 168, a defroster subsystem has turned on, which can similarly be learned and recognized through the reverse transition corresponding to the defroster turning off.

In the event the appliance or a subsystem is reset, it clears the plotted box memory, which allows for future appliance operation to be plotted and learned. When a stable current is identified, a box is subsequently plotted and the sample count for the new subsystem box is incremented. Each new plotted point is periodically checked to see if it lands in an already existing box. If it does. the time for that box is incremented and if the point is near the edge of the box. the box will be expanded. Otherwise a new box is created. This proceeds for a predetermined amount of time, such as 24 and 48 hours or more, which gives ample time for all appliance subsystems, such as the defrost cycle, to occur.

At this point the order of the boxes is random. In this embodiment, the software using a system of permutation and merit. assigns the boxes collected to those shown in FIG. 4. After the assignments are made it is possible to determine which subsystem is on or off.

With the boxes accurately surrounding appliance subsystems, the operational times for the subsystems can be determined. Priority may be given to predetermined subsystems, such as the compressor. The room temperature is then monitored and the operating times are stored relative to room temperature. If a new time value arrives for a temperature slot then a weighting algorithm is applied.

The weighting algorithm of the software can locate the shortest operating time. The controller gives shorter times a higher weight as they are averaged into the table. Concurrently. or subsequently, controller software is looking for the longest non-operating times. As new non-operating times are accumulated, the longer non-operating times are given higher weight as they are averaged in.

As can be appreciated, after a few operating cycles have been accumulated at a given temperature the alarms can be derived and enabled. While various alarm activation scenarios can be utilized by the controller, in various embodiments the alarm is activated if the operating or non-operating times are greater than a derived or predetermined threshold.

In isolation or combination with monitoring the operating time of an appliance subsystem, a non-operating monitor can identify how long a subsystem is not operating. If the power to a subsystem goes off, the monitor can start beeping with one or more beeps, which can change after sustained beeping. Such varying beeping can continue on internal battery or external power so a user can estimate the amount of elapse time number the power has been off by counting the beep sequences. In the event the power comes back on after a short period of time, the alarm can be canceled; however the power outage elapse time can be stored in the memory for future reference. Otherwise the beeping will continue until deactivation, such as by the depression of a cancel button on the appliance or a remote.

The ability to monitor and activate alarms pertaining to appliance subsystem operation and non-operation provides a variety of safety and information that can enhance the performance of an appliance, such as when a subsystem needs to be serviced.

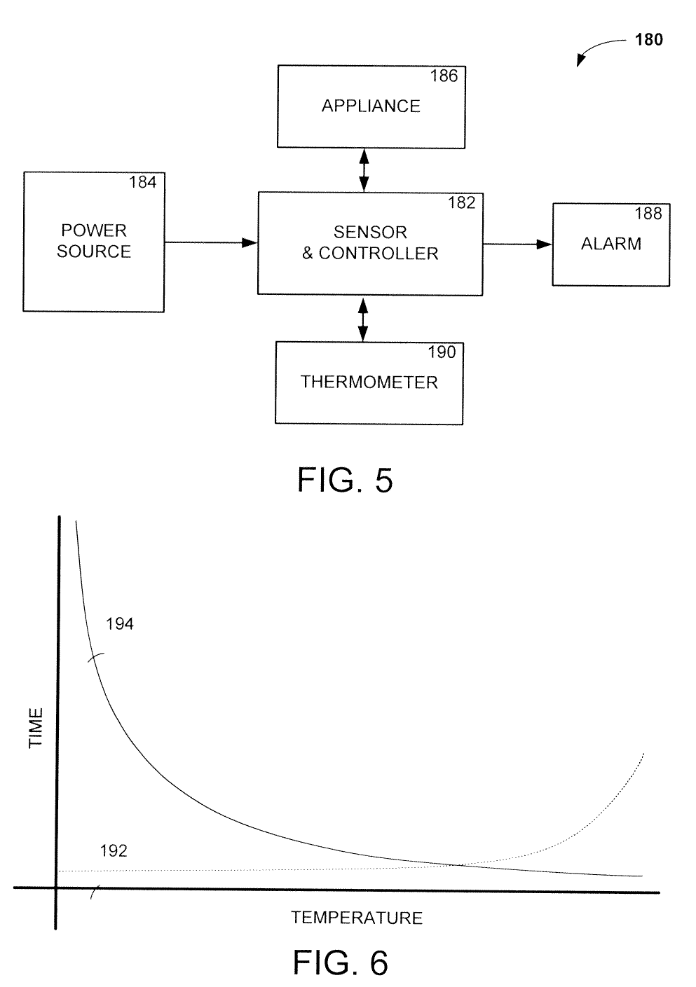

FIG. 5 is a block representation of an example control circuitry 180 constructed and operated in accordance with various embodiments of the present invention. The circuitry 180 has a controller 182 that may be combined with one or more sensors placed throughout the circuitry 180 to detect various unlimited parameters, such as current, temperature, pressure, and operating time. The controller 182 can direct power from a power source 184 to an appliance 186, and any associated appliance subsystems, along with various components either alone or in combination.

One such component may be an alarm 188 that indicates when operation of one or more appliance subsystems surpasses controller generated alarm trip points. The controller 182 may also have one or more thermometers 190 (also referred to herein as a temperature sensor 190) that measure the temperature of any number of environments, such as internal to the appliance, external to the appliance, and individual subsystems. The logging of operating data points in association with time and temperature can provide added layers of accuracy and reliability for the learned appliance environment and the generated alarm trip points.

FIG. 6 graphs an example of a manner in which measured time and temperature aid in the generation of alarm trip points by a controller. At a predetermined temperature for a particular subsystem identified by the graph illustrated in FIG. 4, a run timer can begin and continue until operation ceases. Similarly, a stop timer can continue as long as the subsystem is not operating. The association of these timers with each subsystem and in relation to the temperature of each subsystem can monitor and predict normal subsystem operation. Such associations are generally plotted as lines 194 and 192, which illustrate operational behavior characteristics that may be vastly different for different appliance subsystem. but within normal operating parameters based on measured environmental conditions.

Line 192 is the plot of maximum off time for a freezer versus room temperature. As the room warms up, the heat from the room flows more quickly into the freezer, which corresponds to the maximum off time getting smaller. Line 194 is a plot of the minimum on time for the freezer as a function of room temperature. A warmer external environment can cause more heat to flow into the freezer: hence it will take longer for the compressor to cool down the freezer. While merely exemplary embodiments of operation of a power system monitored by various embodiments of the present invention, the lines 192 and 194 provide reliable real-time estimates of the operating and non-operating time times for various components of a compliance for a given room temperature.

For example, a subsystem identified as corresponding to a particular combination of real and imaginary current can be further associated with a cyclic operating behavior that may or may not correspond to a temperature, such as internal and external temperatures of a refrigerator. The ability to log the operating behavior and history of each subsystem allows for the accurate generation of alarm trip points that take into account current consumed, current environmental conditions, and operating history. The ability to continually adapt the alarm trip points based on external conditions, such as weather, allows for adaptive operation of the appliance monitoring circuitry and more reliable alarm activation.

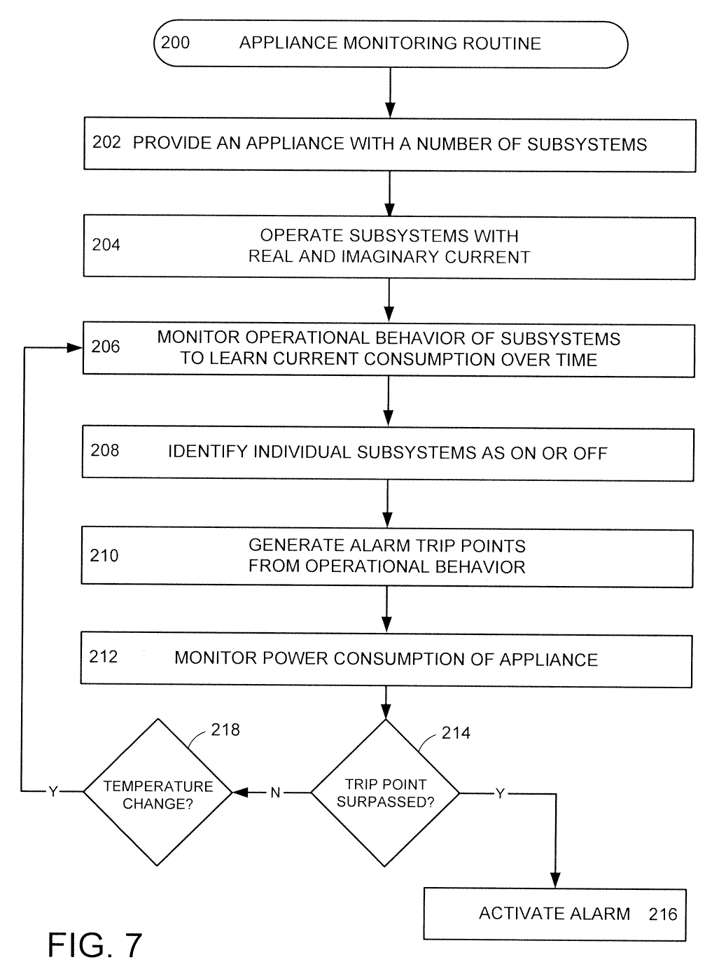

FIG. 7 provides an example flowchart of an appliance monitoring routine 200 conducted in accordance with various embodiments of the present invention. Initially, the routine 200 provides an appliance with a number of appliance subsystems in step 202 that each operate with power provided from a power source. Step 204 then operates the appliance subsystems with real and imaginary current, which is monitored and logged in step 206 to determine the operational behavior of each subsystem and learn the current consumption over time.

The resultant data logged from step 206 can be used to identify the individual appliance subsystems as operating or not in step 208, as generally shown in FIG. 4. Step 210 proceeds to generate alarm trip points from the operational behavior of each subsystem. As discussed above, such operational behavior may include temperature and time measurements that predict future operating times and operating durations. With the alarm trip points set, step 212 continually monitors power consumption of the appliance including each subsystem in relation to the trip points.

As step 212 monitors power consumption, decision 214 evaluates the operating behavior of each subsystem in relation to the trip points and sounds an alarm with step 216 in the event a trip point is surpassed. Meanwhile, decision 218 can continually monitor various temperatures, such as temperatures internal and external to the appliance, to determine if predetermined parameters, such as an adequate temperature difference, are present for the routine 200 to return to step 206 to learn appliance subsystem operational behavior and generate alarm set points.

With the ability to evaluate the external environment in association with learning the operational behavior of each appliance subsystem, the routine 200 can adapt to changing conditions to provide the most accurate alarm notifications and learned environment possible. The ability to continually log operational data and relearn the appliance's subsystems further allows various modifications to be done to the appliance without appliance downtime to reprogram sensors and controller history.

It can be appreciated that a wide variety of appliances and operating behaviors can be monitored, identified, and learned from routine 200. However, the routine 200 is not limited only to the steps and decisions provided in FIG. 7 as any number of steps and determinations can be added, omitted, and modified to accommodate various functions and adaptations. For example, a step could be added that predicts the operating behavior of each subsystem as a function of time and temperature to be used in step 210 to generate alarm trip points.

Further of note is that no particular appliance or appliance subsystem is required or limited to the present disclosure. Any number, orientation, and operation can be evaluated and learned to generate alarm set points. Furthermore, the alarm trip points are not restricted to particular operating parameters as any behavior, such as temperature. pressure, and vibration can be formulated into an alarm trip point.

It should be noted that the term “imaginary current” as used herein shall be construed to mean a current that is ninety degrees out of phase with its corresponding voltage.

It can be appreciated that the novel software and hardware described in the present disclosure allows for enhanced appliance monitoring. The learning of the appliance environment including the operational behavior of each appliance subsystem allows for implementation in any appliance with minimal installation and maintenance downtime. The use of learned operational behavior to generate alarm set points provides increased accuracy and reliability of alarm notifications. Meanwhile, the ability to monitor a number of different operational and environmental parameters allows for the automatic adaptation of the alarm set points in response to changing conditions.

It is to be understood that even though numerous characteristics and configurations of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application without departing from the spirit and scope of the present invention.

1. A method by steps comprising:
operating a number of appliance subsystems electrically connected to a power source with real and imaginary current; and
learning operating characteristics of each appliance subsystem by monitoring with a measurement and data logging system the real and imaginary current consumption of each appliance subsystem over time.

2. The method of claim 1, by steps further comprising:
providing an environment monitoring device;
interfacing the environment monitoring device to the measurement and data logging system;
measuring an environment parameter; and
logging the measured environment parameter within a memory of the measurement and data logging system.

3. The method of claim 2, by steps further comprising:
associating the measured environment parameter with the learned operating characteristics of a select subsystem of the number of appliance subsystems;
establishing an operating profile of the selected subsystem based on the measured environment parameter and the learned operating characteristics of the select subsystem associated with the measured environmental parameter;
selecting boundaries of normal operation of the selected subsystem based on the established operating profile; and
alerting a user when the selected boundaries of normal operation are breached.

4. The method of claim 3, by steps further comprising:
measuring time intervals of operating and non-operating modes of the selected subsystem: and
associating the measured time intervals, of operating and non-operating modes of the selected subsystem, with measured environment parameters.

5. The method of claim 4, further comprising:
determining the shortest operating time for the selected subsystem relative to the measured environment parameter; and
determining the longest operating time for the selected subsystem relative to the measured environment parameter.

6. The method of claim 5, by steps further comprising:
measuring an elapse operating time for the selected subsystem;
collecting a value of the environment parameter during the measured elapse time;
associating the measured elapse time of the selected subsystem with the collected value of the environment parameter;
comparing the measured elapse operating time associated with the collected environment parameter value to each the determined shortest and longest operating time of the selected subsystem associated with the measured environment parameter that most closely relates to the collected environment parameter value; and
discerning whether the selected subsystem is within the selected boundaries of normal operation of the subsystem based on said comparison.

7. The method of claim 4, further comprising:
determining the shortest non-operating time for the selected subsystem relative to the measured environment parameter; and
determining the longest non-operating time for the selected subsystem relative to the measured environment parameter.

8. The method of claim 7, by steps further comprising:
measuring an elapse non-operating time for the selected subsystem;
collecting a value of the environment parameter during the measured elapse time;
associating the measured elapse time of the selected subsystem with the collected value of the environment parameter;
comparing the measured elapse non-operating time associated with the collected environment parameter value to each the determined shortest and longest non-operating time of the selected subsystem associated with the measured environment parameter that most closely relates to the collected environment parameter value; and
discerning whether the selected subsystem is within the selected boundaries of normal non-operation of the subsystem based on said comparison.

9. The method of claim 8, in which the environment monitoring device is selected from a group consisting of a temperature sensor, an audio sensor, a light sensor, a vibration sensor, an impact shock sensor, a motion sensor, and a tactile sensor.

10. The method of claim 6, further comprising:
determining the shortest non-operating time for the selected subsystem relative to the measured environment parameter; and
determining the longest non-operating time for the selected subsystem relative to the measured environment parameter.

11. The method of claim 10, by steps further comprising:
measuring an elapse non-operating time for the selected subsystem;
collecting a value of the environment parameter during the measured elapse time;
associating the measured elapse time of the selected subsystem with the collected value of the environment parameter;
comparing the measured elapse non-operating time associated with the collected environment parameter value to each the determined shortest and longest non-operating time of the selected subsystem associated with the measured environment parameter that most closely relates to the collected environment parameter value; and
discerning whether the selected subsystem is within the selected boundaries of normal non-operation of the subsystem based on said comparison.

11. (canceled)

12. A method by steps comprising:
operating a number of appliance subsystems with power from a power source;
monitoring the power with a sensor over time to learn operating characteristics of each of the appliance subsystems;
generating an alarm trip point in response to the learned operating characteristics of each of the appliance subsystems; and
activating an alarm in response to at least one alarm trip point being surpassed.

13. The method of claim 12, by steps further comprising:
monitoring the power source;
advising a user of the number of subsystems of power outages when power outages occur; and
alerting the user of the number of subsystems of excessive power usage when consumption of excessive power occurs.

14. The method of claim 13, by steps further comprising:
operating a number of appliance subsystems with power from a power source;
monitoring the power with a first sensor over time to learn operating characteristics of each of the appliance subsystems;
generating an alarm trip point in response to the learned operating characteristics of each of the appliance subsystems, the learned operating characteristics have at least one environmental factor capable of changing an expected operation of the subsystem; and
activating an alarm in response to at least one alarm trip point being surpassed.

15. An appliance monitoring system comprising:
a number of appliance subsystems of an appliance;
real and imaginary current associated with each appliance subsystem;
a measurement and data logging system in communication with each of said appliance subsystems; and
at least one sensor interacting with at least one subsystem of the number of appliance subsystems and responsive to said measurement and data logging system, said at least one sensor responsive to said real and imaginary associated with said at least one subsystem.

16. The appliance monitoring system of claim 15, further comprising an environment monitoring device communicating with said measurement and data logging system.

17. The appliance monitoring system of claim 16, in which the measurement and data logging system comprising:
a controller in electrical communication with each the at least one sensor and the environment monitoring device; and
a memory in electrical communication with said controller.

18. The appliance monitoring system of claim 17, further comprising:
software loaded in said memory and executed by said controller; and
an alarm in electronic communication with said controller, and responsive to a signal commanded by said software.

19. The appliance monitoring system of claim 18, in which said memory is a first memory, and further comprising:
a second memory, in electronic communication with said controller, said second memory is a data log memory wherein measured values and sensed parameters ore stored; and
an elapse time measurement circuit communicating with said controller and responsive to commands initiating from said software.

20. The appliance monitoring system of claim 19, in which said environment monitoring device is selected from a group consisting of: a temperature sensor; an audio sensor; a light sensor; a vibration sensor; an impact shock sensor; a motion sensor; and a tactile sensor.
